(19) United States
(12) Patent Application Publication
(10) Pub. No.: US 2021/0281808 A1
(43) Pub. Date: Sep. 9, 2021

(54) PROJECTION SYSTEM AND PROJECTION CORRECTION METHOD

(71) Applicants: BenQ Intelligent Technology (Shanghai) Co., Ltd, Shanghai (CN); BENQ CORPORATION, Taipei (TW)

(72) Inventors: Chen-Cheng Huang, Taoyuan City (TW); Tung-Chia Chou, New Taipei City (TW)

(21) Appl. No.: 16/886,790

(22) Filed: May 29, 2020

(30) Foreign Application Priority Data
Mar. 3, 2020 (CN) 202010139931.5

(51) Int. Cl. H04N 9/31

(52) U.S. Cl. CPC H04N 9/3182; H04N 9/3194

(57) ABSTRACT

A projection system includes a plurality of projection units, a sensing module and a processing unit. The projection units project a plurality of images. The sensing module senses a current optical parameter of each of the images to obtain a plurality of current optical parameters. The processing unit communicates with the projection units and the sensing module. The processing unit receives the current optical parameters from the sensing module, determines a target optical parameter according to the current optical parameters, and transmits a control signal to each of the projection units. Each of the projection units adjusts the current optical parameter to the target optical parameter in response to the control signal.

### BACKGROUND OF THE INVENTION

### 1. Field of the Invention

The invention relates to a projection system and a projection correction method and, more particularly, to a projection system and a projection correction method capable of automatically correcting brightness and/or color of a plurality of projection units.

### 2. Description of the Prior Art

Recently, projectors are getting more and more popular. With the capacity of video playing, projectors are applied not only for common office meetings, but also for various seminars or academic courses. In general, there is a limitation on the resolution and aspect ratio of each projector. Therefore, at some sites, a plurality of images projected by a plurality of projectors need to be blended according to the size of a projection plane and/or the desired resolution. When brightness and/or color projected by the projectors are different, a visual effect of a blended image formed by the projectors will be affected.

### SUMMARY OF THE INVENTION

The invention provides a projection system and a projection correction method capable of automatically correcting brightness and/or color of a plurality of projection units, so as to solve the aforesaid problems.

According to an embodiment of the invention, a projection system comprises a plurality of projection units, a sensing module and a processing unit. The projection units project a plurality of images. The sensing module senses a current optical parameter of each of the images to obtain a plurality of current optical parameters. The processing unit communicates with the projection units and the sensing module. The processing unit receives the current optical parameters from the sensing module, determines a target optical parameter according to the current optical parameters, and transmits a control signal to each of the projection units. Each of the projection units adjusts the current optical parameter to the target optical parameter in response to the control signal.

According to another embodiment of the invention, a projection correction method comprises steps of projecting a plurality of images by a plurality of projection units; sensing a current optical parameter of each of the images by a sensing module to obtain a plurality of current optical parameters; determining a target optical parameter according to the current optical parameters and transmitting a control signal to each of the projection units by a processing unit; and adjusting the current optical parameter to the target optical parameter in response to the control signal by each of the projection units.

As mentioned in the above, the invention utilizes the sensing module to sense the current optical parameter (e.g. current brightness and/or current color) of the image projected by each of the projection units and determines the target optical parameter (e.g. target brightness and/or target color) according to the current optical parameters. Then, the invention uses the target optical parameter to adjust the current optical parameter of the image projected by each of the projection units to the target optical parameter. In other words, the invention uses the target optical parameter to adjust the current optical parameter of the image projected by each of the projection units to be consistent, so as to improve a visual effect of a blended image formed the projection units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a projection system according to an embodiment of the invention.

FIG. 2 is a functional block diagram illustrating the projection system according to an embodiment of the invention.

FIG. 3 is a functional block diagram illustrating a projection system according to another embodiment of the invention.

FIG. 4 is a flowchart illustrating a projection correction method according to an embodiment of the invention.

### DETAILED DESCRIPTION

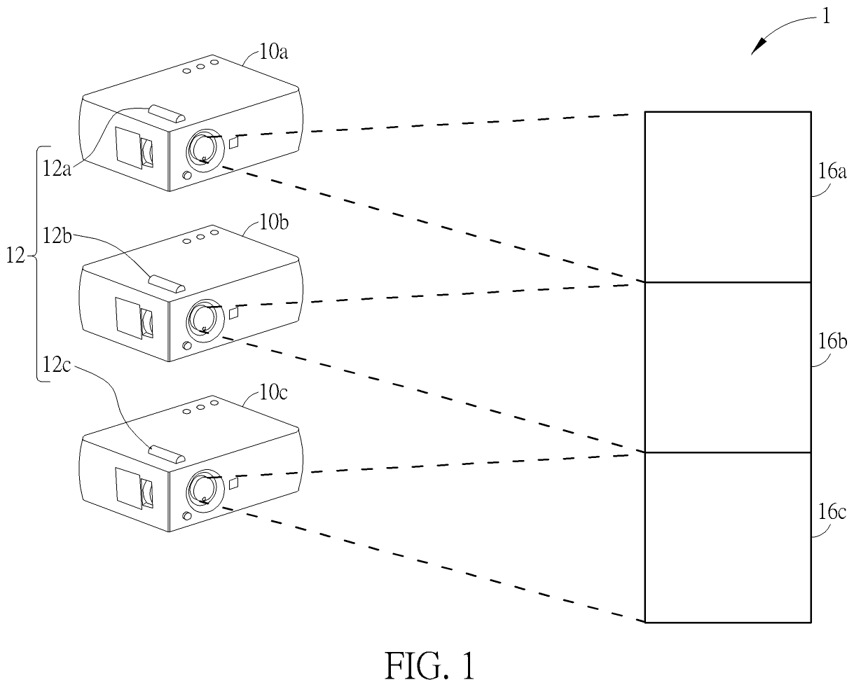

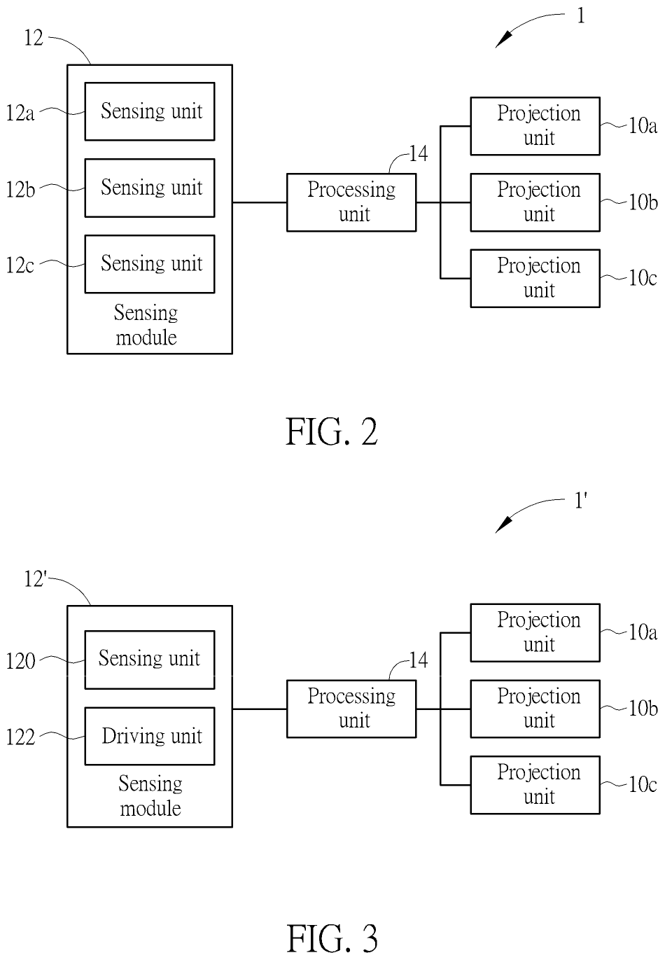

Referring to FIGS. 1 and 2, FIG. 1 is a schematic diagram illustrating a projection system 1 according to an embodiment of the invention and FIG. 2 is a functional block diagram illustrating the projection system 1 according to an embodiment of the invention.

As shown in FIGS. 1 and 2, the projection system 1 comprises a plurality of projection units 10a-10c, a sensing module 12 and a processing unit 14, wherein the processing unit 14 communicates with the projection units 10a-10c and the sensing module 12. The processing unit 14 may be a processor or a controller with signal processing/calculating function. In this embodiment, the projection system 1 comprises three projection units 10a-10c. It should be noted that the number of projection units of the invention maybe determined according to practical applications, so the invention is not limited to the embodiment shown in the figures. In this embodiment, the projection units 10a-10c are projectors.

The projection units 10a-10c are configured to project a plurality of images 16a-16c to form a blended image. The sensing module 12 is configured to sense a current optical parameter of each of the images 16a-16c to obtain a plurality of current optical parameters. In this embodiment, the sensing module 12 may comprise a plurality of sensing units 12a-12c, wherein each of the sensing units 12a-12c is disposed with respect to one of the projection units 10a-10c. In other words, the sensing units 12a-12c are disposed with respect to the projection units 10a-10c in a one-to-one manner. Accordingly, the number of sensing units 12a-12c corresponds to the number of projection units 10a-10c. In this embodiment, the sensing units 12a-12c may be light sensors, cameras or a combination thereof according to practical applications.

Each of the sensing units 12a-12c is configured to sense the current optical parameter of the image 16a-16c projected by one of the projection units 10a-10c. For further illustration, a sensing range of the sensing unit 12a covers the image 16a projected by the projection unit 10a, such that the sensing unit 12a can sense the current optical parameter of the image 16a projected by the projection unit 10a. Furthermore, a sensing range of the sensing unit 12b covers the image 16b projected by the projection unit 10b, such that the sensing unit 12b can sense the current optical parameter of the image 16b projected by the projection unit 10b. Moreover, a sensing range of the sensing unit 12c covers the image 16c projected by the projection unit 10c, such that the sensing unit 12c can sense the current optical parameter of the image 16c projected by the projection unit 10c.

The processing unit 14 receives the current optical parameters from the sensing units 12a-12c of the sensing module 12. Then, the processing unit 14 determines a target optical parameter according to the current optical parameters and transmits a control signal to each of the projection units 10a-10c. At this time, each of the projection units 10a-10c adjusts the current optical parameter to the target optical parameter in response to the control signal. In this embodiment, the target optical parameter may be set to be an average value, a minimum value, a maximum value or a predetermined value of the current optical parameters according to practical applications.

In an embodiment, the current optical parameter may be a current brightness and the target optical parameter may be a target brightness. At this time, each of the projection units 10a-10c adjusts the current brightness to the target brightness in response to the control signal. For example, it is assumed that the current brightness of the image 16a projected by the projection unit 10a is 5100 lux, the current brightness of the image 16b projected by the projection unit 10b is 5300 lux, and the current brightness of the image 16c projected by the projection unit 10c is 5200 lux. When the target brightness is the average value of the three current brightness, the target brightness is 5200 lux; when the target brightness is the minimum value of the three current brightness, the target brightness is 5100 lux; and when the target brightness is the maximum value of the three current brightness, the target brightness is 5300 lux. It should be noted that if an initial brightness of each of the projection units 10a-10c is outputted by 100%, it means that the brightness of each of the projection units 10a-10c cannot be increased anymore. At this time, the target brightness may be set to be the minimum value of the three current brightness, so as to ensure that the current brightness of each of the projection units 10a-10c can be adjusted to the target brightness.

In another embodiment, the current optical parameter may be a current color and the target optical parameter may be a target color. At this time, each of the projection units 10a-10c adjusts the current color to the target color in response to the control signal. In this embodiment, the current color and the target color may be represented by, but not limited to, color coordinate (x, y). For example, it is assumed that the current color of the image 16a projected by the projection unit 10a is W(0.321, 0.333), the current color of the image 16b projected by the projection unit 10b is W(0.317, 0.330), and the current color of the image 16c projected by the projection unit 10c is W(0.325, 0.336), wherein W represents that the current color is white. When the target color is the average value of the three current colors, the target color is W(0.321, 0.333); when the target color is the minimum value of the three current colors, the target color is W(0.317, 0.330); and when the target color is the maximum value of the three current colors, the target color is W(0.325, 0.336). It should be noted that the target color has to conform to a color standard of Rec. 709. In other words, the target color has to be set according to the color standard of Rec. 709.

It should be noted that the invention may correct brightness or color individually or correct brightness and color simultaneously according to practical applications.

In an embodiment, the processing unit 14 may be a processor disposed in one of the projection units 10a-10c, wherein the projection units 10a-10c may communicate with each other by a wired or wireless manner. In other words, the aforesaid calculation and correction may be performed by the processor or controller of one of the projection units 10a-10c. In another embodiment, the processing unit 14 may be a processor disposed in an external computer, wherein the projection units 10a-10c may communicate with the external computer by a wired or wireless manner. In other words, the aforesaid calculation and correction may be performed by the processor or controller of the external computer. It should be noted that the wired or wireless communication is well known by one skilled in the art, so the explanation will not be depicted herein.

Referring to FIG. 3, FIG. 3 is a functional block diagram illustrating a projection system 1′ according to another embodiment of the invention. The main difference between the projection system 1′ and the aforesaid projection system 1 is that the sensing module 12′ of the projection system 1′ comprises a sensing unit 120 and a driving unit 122, as shown in FIG. 3. The aforesaid sensing module 12 may be replaced by the sensing module 12′. The driving unit 122 is configured to drive the sensing unit 120 to move with respect to the projection units 10a-10c, such that the sensing unit 120 can sense the current optical parameter of each of the images 16a-16c. For example, the driving unit 122 may drive the sensing unit 120 to move first to enable a sensing range of the sensing unit 120 to cover the image 16a projected by the projection unit 10a, such that the sensing unit 120 can sense the current optical parameter of the image 16a projected by the projection unit 10a. Then, the driving unit 122 may drive the sensing unit 120 to move to enable the sensing range of the sensing unit 120 to cover the image 16b projected by the projection unit 10b, such that the sensing unit 120 can sense the current optical parameter of the image 16b projected by the projection unit 10b. Then, the driving unit 122 may drive the sensing unit 120 to move to enable the sensing range of the sensing unit 120 to cover the image 16c projected by the projection unit 10c, such that the sensing unit 120 can sense the current optical parameter of the image 16c projected by the projection unit 10c. Accordingly, the processing unit 14 receives a plurality of current optical parameters sequentially from the sensing unit 120 of the sensing module 12′. After receiving current optical parameters sequentially, the processing unit 14 determines the target optical parameter according to the current optical parameters and transmits the control signal to each of the projection units 10a-10c. At this time, each of the projection units 10a-10c adjusts the current optical parameter to the target optical parameter in response to the control signal.

In this embodiment, the sensing unit 120 may be a light sensor, a camera or a combination thereof according to practical applications. Furthermore, the driving unit 122 may essentially consist of motor, linkage, gear, rack and/or other linking components according to practical applications. It should be noted that the term “move” mentioned in the above may comprise “rotate”, “linearly move” or a combination thereof according to practical applications.

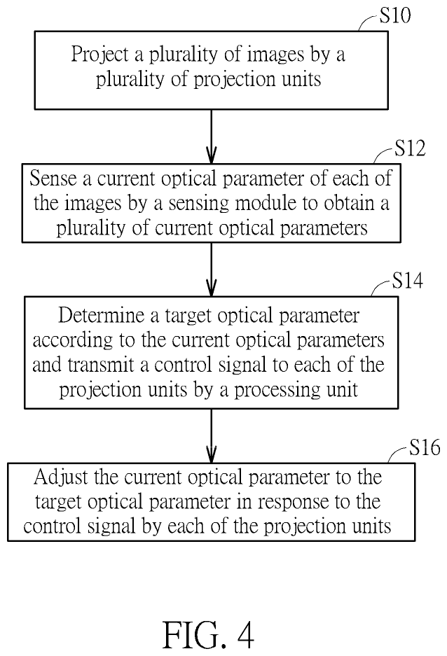

Referring to FIG. 4, FIG. 4 is a flowchart illustrating a projection correction method according to an embodiment of the invention. The projection correction method shown in FIG. 4 is adapted to the aforesaid projection systems 1, 1′. First, step S10 is performed to project a plurality of images 16a-16c by a plurality of projection units 10a-10c. Then, step S12 is performed to sense a current optical parameter of each of the images 16a-16c by a sensing module 12 to obtain a plurality of current optical parameters. Then, step S14 is performed to determine a target optical parameter according to the current optical parameters and transmit a control signal to each of the projection units 10a-10c by a processing unit 14. Then, step S16 is performed to adjust the current optical parameter to the target optical parameter in response to the control signal by each of the projection units 10a-10c.

It should be noted that the detailed embodiments of the projection correction method of the invention are mentioned in the above and those will not be depicted herein again. Furthermore, each part or function of the control logic of the projection correction method of the invention may be implemented by software, hardware or the combination thereof.

As mentioned in the above, the invention utilizes the sensing module to sense the current optical parameter (e.g. current brightness and/or current color) of the image projected by each of the projection units and determines the target optical parameter (e.g. target brightness and/or target color) according to the current optical parameters. Then, the invention uses the target optical parameter to adjust the current optical parameter of the image projected by each of the projection units to the target optical parameter. In other words, the invention uses the target optical parameter to adjust the current optical parameter of the image projected by each of the projection units to be consistent, so as to improve a visual effect of a blended image formed the projection units.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection system comprising:
a plurality of projection units projecting a plurality of images;
a sensing module sensing a current optical parameter of each of the images to obtain a plurality of current optical parameters; and
a processing unit communicating with the projection units and the sensing module, the processing unit receiving the current optical parameters from the sensing module, determining a target optical parameter according to the current optical parameters, and transmitting a control signal to each of the projection units, each of the projection units adjusting the current optical parameter to the target optical parameter in response to the control signal.

2. The projection system of claim 1, wherein the current optical parameter is a current brightness and the target optical parameter is a target brightness.

3. The projection system of claim 1, wherein the current optical parameter is a current color and the target optical parameter is a target color.

4. The projection system of claim 1, wherein the target optical parameter is an average value, a minimum value, a maximum value or a predetermined value of the current optical parameters.

5. The projection system of claim 1, wherein the sensing module comprises a plurality of sensing units, each of the sensing units is disposed with respect to one of the projection units, and each of the sensing units senses the current optical parameter of the image projected by one of the projection units.

6. The projection system of claim 1, wherein the sensing module comprises a sensing unit and a driving unit, the driving unit drives the sensing unit to move with respect to the projection units, such that the sensing unit senses the current optical parameter of each of the images.

7. A projection correction method comprising:
projecting a plurality of images by a plurality of projection units;
sensing a current optical parameter of each of the images by a sensing module to obtain a plurality of current optical parameters;
determining a target optical parameter according to the current optical parameters and transmitting a control signal to each of the projection units by a processing unit; and
adjusting the current optical parameter to the target optical parameter in response to the control signal by each of the projection units.

8. The projection correction method of claim 7, wherein the current optical parameter is a current brightness and the target optical parameter is a target brightness.

9. The projection correction method of claim 7, wherein the current optical parameter is a current color and the target optical parameter is a target color.

10. The projection correction method of claim 7, wherein the target optical parameter is an average value, a minimum value, a maximum value or a predetermined value of the current optical parameters.

11. The projection correction method of claim 7, wherein the sensing module comprises a plurality of sensing units, each of the sensing units is disposed with respect to one of the projection units, and each of the sensing units senses the current optical parameter of the image projected by one of the projection units.

12. The projection correction method of claim 7, wherein the sensing module comprises a sensing unit and a driving unit, the driving unit drives the sensing unit to move with respect to the projection units, such that the sensing unit senses the current optical parameter of each of the images.
